(19) United States
(12) Patent Application Publication
(10) Pub. No.: US 2023/0278293 A1
(43) Pub. Date: Sep. 7, 2023

(54) SYSTEMS AND METHODS FOR MINIMIZING SHRINKAGE OF RESIN-PRINTED PARTS DURING ADDITIVE MANUFACTURING

(71) Applicant: 3DFORTIFY INC., Boston, MA (US)

(72) Inventors: Verena GARGITTER, Boston, MA (US); Tyler Alexander KAUFMAN, Boston, MA (US); Alexander Thomas QUINN, Somerville, MA (US)

(21) Appl. No.: 18/116,271

(22) Filed: Mar. 1, 2023

Related U.S. Application Data
(60) Provisional application No. 63/315,518, filed on Mar. 1, 2022.

(51) Int. Cl. B29C 64/393; B29C 64/232; B29C 64/245; B29C 64/321

(52) U.S. Cl. CPC B29C 64/393; B29C 64/232; B29C 64/245; B29C 64/321; B33Y 30/00

(57) ABSTRACT

Systems and methods for combatting shrinking forces within drying photopolymers of additive manufacturing processes are disclosed herein. According to at least some embodiments, layers of an additive manufacturing build are split into core components and shell components. Magnetically active additives within the photopolymer resin are then aligned in a first plane while the core section is cured, and a second plane while the outer shell section is cured. According to at least some embodiments, the first plane and the second plane are perpendicular.

### CROSS-REFERENCE TO RELATED APPLICATIONS

This application claims the benefit of and priority from U.S. Provisional Application No. 63/315,518, filed Mar. 1, 2022, the disclosures of which is hereby incorporated by reference herein in its entirety.

### FIELD

The present disclosure relates to systems and methods for minimizing shrinkage of resin-printed components in photopolymerization additive manufacturing, and more particularly relates to improving geometric tolerance and warping resistance of three-dimensionally (3D)-printed parts with programmable magnetic additive alignment in a composite resin material.

### BACKGROUND

Part shrinking and curling is a common problem plaguing digital light processing (DLP), stereolithography (SLA), and liquid crystal display (LCD) resin printing, where the polymerization of cured resin leads to significant deformation of the printed part. Achieving dimensional accuracy in 3D-printed (“3D” can at least represent three-dimensionally, three-dimensional, and three-dimensions, among other variations known to those skilled in the art) parts is difficult to accomplish and a well-understood problem in industry. In a resin printing process, polymerization techniques result in a shrinking for which those producing precision components must account. Most photoresin systems typically shrink between 3% and 8% (or more) during cure, and unfavorable and/or undesirable work-arounds are often required to produce geometrically accurate parts.

Currently employed techniques are often insufficient and can negatively affect the print time and/or part aesthetics. Many printing systems apply a scaling factor to enlarge input dimensions to account for shrinking. These techniques are generally insufficient to ensure accuracy because parts of varied thickness and geometries may deform at different rates. Scaling factors can produce inconsistent results when printing parts of varying thickness and cross-section. Large parts must typically be printed at an angle with build supports to avoid curing large cross-sections at once, which can increase print time and add layer steps in areas that are desired to be smooth.

An alternate solution is to formulate resin systems using materials that do not shrink significantly when cured. However, the physical properties of these low-shrink resins are limited, and not useful for many applications, including industrial applications. Yet another practice is to “undercure” resin, where one provides insufficient light energy to fully polymerize the resin. This also results in less shrinking, as fewer of the monomers and oligomers in the resin are incorporated into the polymer network. However, because the resin is not fully polymerized in curing, various physical properties of the printed product are not useful for many applications. As such, these prior techniques require a trade-off between desired physical properties and printing accuracy.

Accordingly, there is a need for effective ways to regulate undesirable shrinking of printed components in an additive manufacturing process to allow for parts to be properly rendered without undesirable curing, under-curing, and/or over-curing in portions of the printed parts.

### SUMMARY

The present disclosure provides for systems, devices, and methods for minimizing shrinking of resin-printed components utilizing a technique sometimes referred to herein as “shelling.” The disclosure results in a Digital Composite Manufacturing (DCM) platform that can be leveraged to mitigate resin shrink and produce dimensionally accurate parts without the common compromises seen using existing techniques. As described herein, a magnetic alignment module can be built onto an existing or new 3D printer to direct and control resin shrinkage by programming additive orientation within the resin matrix. The present disclosure details a set of technical processing approaches in which particle alignment is leveraged within printed parts to improve, among other things, geometric tolerancing. In at least some instances, unconventional architectures of particle alignment can be used to combat photopolymerization shrinkage that often results in part warpage. The design of these architectures can be generalized to bespoke part geometries through a series of developing design principles.

In at least some embodiments, the disclosed methods, and related systems and devices capable of performing the methods, leverage magnetically-responsive additives in a composite resin material to program shrinkage and resist deformation of printed parts. In such embodiments, by aligning additives such that their long axes are planar with an x-y plane of a printer, the printed part resists shrinkage forces in the x-y plane, in turn improving tolerances and flatness. In other or the same embodiments, additives can be aligned such that their long axes are parallel to the printer z-axis, improving part surface roughness and z-direction mechanics. According to at least some embodiments of the present disclosure, a printing technique can incorporate both additive orientations to produce smooth, strong, accurate parts with minimal shrinking and/or warping by aligning the additives in the interior area or bulk “core” of the part in the x-y plane, then aligning the additives in the thin perimeter of the part, called the “shell” of the part, in the z-direction. The term “shelling” to describe the technique derives its name due to the alignment that occurs in the “shell” of the part.

By programming additives to help prevent shrinking, the present disclosure provides for systems and methods that maintain both dimensional accuracy and intended physical part properties, making these systems and methods ideal for, by way of non-limiting example, 3D-printed injection mold tooling applications. Properly oriented additives can significantly reduce shrinkage and maintain dimensional tolerances without having to reformulate resin systems. The disclosed systems and methods allow for resin formulations that would typically exhibit a large shrink percentage (approximately in the range of about 5% to about 10% linear shrinkage) to retain optimal physical properties, including, e.g., tensile strength and surface roughness, paired with geometric accuracy.

One embodiment of a digital light processing (DLP) printer includes a reservoir, a magnetic field generator, a build plate, a digital light projector, and a processor. The reservoir is configured to have a photopolymer resin material disposed in it. The photopolymer resin includes a plurality of magnetically active additives. The build plate is disposed above the reservoir and is configured to at least move along a vertical axis, away from the reservoir. The digital light projector is configured to project an image of a part to be printed towards the reservoir. The processor is configured to perform a variety of functions. This includes: subdivide a build file into at least one printing layer; create a first image and a second image for the at least one printing layers; instruct the magnetic field generator to apply a first magnetic field; instruct the digital light projector to project the first image; instruct the magnetic field generator to apply a second magnetic field; and instruct the digital light projector to project the second image. The first magnetic field and the second magnetic field are out of phase.

In at least some embodiments the first image can include a core image, and the core image can include an interior area of an image to be printed on the at least one printing layer. Further, the second image can include a shell image, with the shell image including a perimeter of the image to be printed on the at least one printing layer. The shell area can include a perimeter of constant thickness. The first magnetic field can include a substantially uniform vector field, and vectors of the substantially uniform vector field can be directed in the x-y plane. The second magnetic field can likewise include a substantially uniform vector field, and vectors of the substantially uniform vector field can be directed along the z axis.

One embodiment of a method for printing a part using digital light processing (DLP) printing can include subdividing a build file into at least one printing layer and plunging a build plate of a DLP printer into a composite resin. The composite resin can include magnetically active additives. The method can further include curing, with a digital light processor, a first image of the at least one printing layer and applying a magnetic field having a first phase to the at least one printing layer. The method can also include curing, with the digital light processor, a second image of the at least one printing layer and applying a magnetic field having a second phase to the at least one printing layer.

In at least some embodiments, the first image can include a core image, and the core image can include a majority of an image to be printed on the at least one printing layer. Further, the second image can include a shell image, and the shell image can include a perimeter of the image to be printed on the at least one printing layer. The shell image can include a perimeter of constant thickness. The first magnetic field can include a substantially uniform vector field, and vectors of the substantially uniform vector field can be directed in the x-y plane. The second magnetic field can likewise include a substantially uniform vector field, and vectors of the substantially uniform vector field can be directed along the z axis.

Another embodiment of a digital light processing (DLP) printer includes a reservoir, a build plate, a digital light projector, and a processor. The reservoir is configured to have a photopolymer resin material disposed in it. The photopolymer resin includes a plurality of magnetically active additives. The build plate is disposed above the reservoir and is configured to at least move along a vertical axis, away from the reservoir. The digital light projector is configured to project an image of a part to be printed towards the reservoir. The processor is configured to perform a variety of functions. This includes: subdivide a build file into at least one printing layer; subdivide the at least one printing layer into a plurality of sublayers; create a first image corresponding to a first sublayer, the first image being in a first checkerboard pattern; instruct the digital light projector to project the first image; instruct the build plate to move to a position corresponding to a second sublayer; create a second image corresponding to the second sublayer, the second image being is in a second checkerboard pattern; instruct the digital light projector to project the second image; instruct the build plate to move to a position corresponding to a third sublayer; create a third image corresponding to the third sublayer, the third image being in the first checkerboard pattern; and instruct the digital light projector to project the third image.

In at least some embodiments each of the first image, the second image, and the third image can include an interior area core and an edge shell. In at least some such embodiments, the DLP printer can further include a magnetic field generator that is capable of generating a magnetic field. The magnetic field generated by the magnetic field generator can be in a first phase when the digital light projector is instructed to project the interior area core of each of the first image, the second image, and the third image, and the magnetic field generated by the magnetic field generator can be in a second phase when the digital light projector is instructed to project the edge shell of each of the first image, the second image, and the third image.

One embodiment of a method for printing a part using digital light processing (DLP) printing includes subdividing a build file into at least one printing layer and subdividing the at least one printing layer into a plurality of sublayers. The method also includes creating a first image corresponding to a first sublayer, with the first image being in a first checkerboard pattern, instructing the digital light projector to project the first image, and instructing the build plate to move to a position corresponding to a second sublayer. The method further includes creating a second image corresponding to the second sublayer, with the second image being is in a second checkerboard pattern, instructing the digital light projector to project the second image, and instructing the build plate to move to a position corresponding to a third sublayer. Additionally, the method includes creating a third image corresponding to the third sublayer, with the third image being in the first checkerboard pattern, and instructing the digital light projector to project the third image.

In at least some embodiments each of the first image, the second image, and the third image can include an interior area core and an edge shell. In at least some such embodiments, a magnetic field generated by a magnetic field generator can be in a first phase when the digital light projector is instructed to project the interior area core of each of the first image, the second image, and the third image, and the magnetic field can be in a second phase when the digital light projector is instructed to project the edge shell of each of the first image, the second image, and the third image.

### BRIEF DESCRIPTION OF DRAWINGS

The accompanying figures incorporated in and forming a part of this specification illustrate several aspects of the disclosure and, together with the description, serve to illustrate at least some principles of the disclosure:

FIG. 1A is a perspective view of one embodiment of a printing apparatus with which the printing systems and methods of the present disclosure can be used;

FIG. 1B is a side view of the printing apparatus of FIG. 1A having a side panel of a housing removed to illustrate components of the printing apparatus disposed within the housing;

FIG. 2 is a flowchart showing steps of a method for printing a part using digital light processing (DLP) printing while minimizing the shrinking of a resin component according to at least some embodiments of the present disclosure;

FIG. 3A shows an image from a step of the method of FIG. 2 representing a “core” image that can be an interior area of a cross section of a printed part;

FIG. 3B shows an image from a step of the method of FIG. 2 representing a “shell” image that can be a border of the core image of FIG. 3A in some thickness of x-pixels of a printed part;

FIG. 4 shows an image from a step of the method of FIG. 2 representing a “core” with additives in an x-y plane and a “shell” with additives aligned parallel, or substantially parallel, to the z-axis according to at least some embodiments of the present disclosure;

FIG. 5A shows a sample of a part printed using the systems and methods disclosed herein where the change in additive alignment can be observed as a change in color near a perimeter of each part layer;

FIG. 5B shows a schematic illustration of a granite surface plate for measuring parallelism of a printed part;

FIG. 5C shows a sample of a test geometry printed using the systems and methods disclosed herein where the change in additive alignment can be observed as a change in color near a perimeter of each part layer;

FIG. 6A is a chart showing a relative height of portions of a test geometry having additives substantially aligned in the z-direction;

FIG. 6B is a chart showing a relative height of portions of a test geometry utilizing systems and methods of shelling techniques disclosed herein;

FIG. 7A is a depiction of a first step of a castellation method according to at least one embodiment;

FIG. 7B is a depiction of a second step of the castellation method provided for in FIG. 7A;

FIG. 7C is a depiction of a third step of the castellation method provided for in FIGS. 7A and 7B;

FIG. 7D is a depiction of a fourth omnibus step of the castellation method provided for in FIGS. 7A-7C;

FIG. 8A is a depiction of a first step of a castellation and shelling method according to at least one embodiment;

FIG. 8B is a depiction of a second step of the castellation and shelling method provided for in FIG. 8A;

FIG. 8C is a depiction of a third step of the castellation and shelling method provided for in FIGS. 8A and 8B;

FIG. 8D is a depiction of a fourth omnibus step of the castellation and shelling method provided for in FIGS. 8A-8C; and

FIG. 9 a schematic block diagram of one embodiment of a computer system for use in conjunction with the present disclosures.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Terms commonly known to those skilled in the art may be used interchangeably herein. Further, a person skilled in the art will appreciate what the meaning of terms like “substantially” mean in the context of their usage. The foregoing notwithstanding, unless otherwise defined or understood by a person skilled in the art, “substantially” will generally mean within about ±5 units or values referenced in the particular context. Accordingly, if something is “substantially uniform,” it is within ±5% of being uniform, and if two components or aspects are substantially parallel, they are within ±5° of being parallel.

In the following description, numerous specific details are set forth by way of examples to provide a thorough understanding of the relevant teachings. However, it should be apparent to those skilled in the art that the present teachings may be practiced without such details. In other instances, well-known methods, procedures, components, and/or circuitry may have been described at a relatively high-level, without detail, to avoid unnecessarily obscuring aspects of the present disclosure. While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspects of the disclosed concepts to the embodiments illustrated. As will be realized, the subject technology is capable of other and different configurations, several details are capable of modification in various respects, embodiments may be combine, steps in the flow charts or otherwise described herein may be omitted or performed in a different order, all without departing from the scope of the subject technology. Accordingly, the drawings, flow charts, and detailed description are to be regarded as illustrative in nature and not as restrictive.

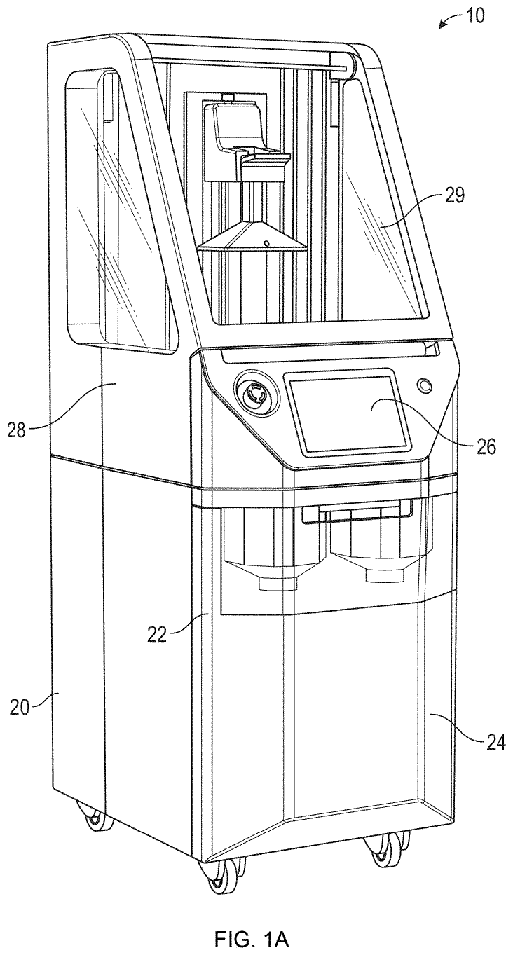

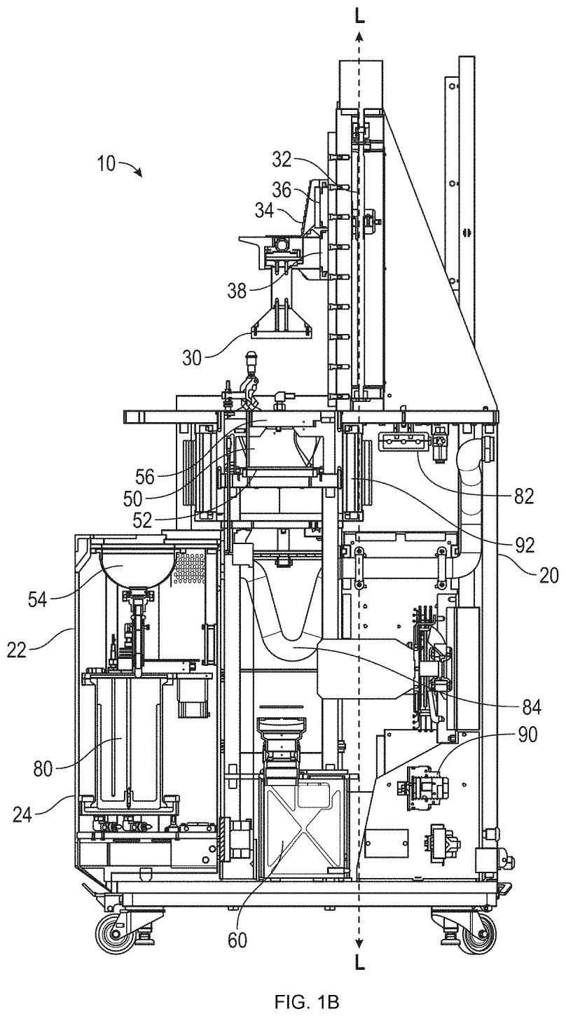

The present disclosure provides for systems and methods that minimize undesirable printing effects in photopolymer based additive manufacturing processes, including digital light processing (DLP), stereolithography (SLA), and liquid crystal display (LCD) techniques. In particular, these systems and methods address known issues of part shrinking and curling that plague these various additive manufacturing processes such that polymerization of cured resin leads to significant deformation of the printed part. Before describing these systems and methods, it may be helpful to provide a non-limiting example of an additive manufacturing printer with which the systems and methods can be used. Accordingly, a non-limiting embodiment of a DLP printer is provided with respect to FIGS. 1A and 1B herein.

FIGS. 1A and 1B illustrate one exemplary embodiment of a FLUX ONE 3D printer 10 of 3DFortify Inc. (Boston, Mass.). The printer 10 includes an outer casing or housing 20 in which various components of the printer 10 are disposed. The FLUX ONE 3D printer is designed to use a bottom-up printing technique, and thus includes a build plate 30 that can be advanced vertically, substantially parallel to a longitudinal axis L of the printer 10 such that the build plate 30 can be moved vertically away from a print reservoir or tank 50 in which resin to be cured to form a desired part, such as resins as provided for above, is disposed. Generally, the build plate 30 can be advanced up and down with respect to a linear rail 32 as desired, the linear rail 32 being substantially colinear with the longitudinal axis L. As a result, the rail 32 can be considered a vertical rail. The build plate 30 can be associated with the linear rail 32 by way or one or more coupling components, such as arm or armatures 34, guides 36, 38, and/or other structures known to those skilled in the art for creating mechanical links that allow one component to move with respect to another.

As described herein, as the build plate 30 moves away from the print reservoir 50, the resin is cured to the build plate 30 and/or to already cured resin to form the printed part in a layer-by-layer manner as the build plate 30 advances away from the reservoir 50. The resin is cured, for example, by a light source and/or a radiation source, as shown a digital light projector 60. The reservoir 50 can include a glass base 52 to allow the digital light projector 60 to pass light into the reservoir 50 to cure the resin. The glass base 52 can more generally be a transparent platform through which light and/or radiation can pass to selective cure the resin. Resin can be introduced to the printer 10 by way of a materials dock 54 that can be accessible, for example via a drawer 22, formed as part of the housing 20.

One or more mixers can be included to help keep the resin viscous and homogeneous. More particularly, at least one mixer, as shown an external mixer 80, can be in fluid communication with the print reservoir 50 to allow resin to flow out of the reservoir 50, into the mixer 80 to be mixed, and then flow back into the reservoir 50 after it has been mixed by the mixer 80. The mixer 80 can be accessible, for example, via a front panel door 24 provided as part of the housing 20. At least one heating element 82 can be included for use in conjunction with the mixer 80 such that the treated (i.e., mixed) resin is also heated. In the illustrated embodiment the heating element 82 is disposed proximate to the print reservoir 50, heating the resin after it has been mixed by the mixer 80, although other location are possible, including but not limited to being incorporated with the mixer 80 to heat and mix simultaneously and/or consecutively. The resin can be heated more than once by additional heating elements as well.

Resin that travels from the reservoir 50, to the mixer 80, and back to the reservoir 50 can flow through any number of conduits or tubes configured to allow resin to travel therethrough, such as the conduits 84 illustrated in FIG. 1B.

The resin can also flow through a reservoir manifold 56, which can be disposed above the print reservoir 50. The manifold 56 can serve a variety of purposes, including but not limited to helping to maintain the position of the reservoir 50 during operation, and helping to facilitate mechanical, electrical, and fluid connections between the reservoir and other components of the printer 10. For example, the manifold can be designed to allow resin to be mixed and/or heated to flow out of the reservoir 50, as well as allow mixed and/or heated resin to flow into the reservoir 50 via ports formed therein. Electrical connections to help operate various features associated with the reservoir 50, such as monitoring of a level of resin and/or monitoring an orientation of one or more components disposed and/or otherwise situated with respect to the reservoir 50, can be passed through the manifold 56. The electrical connections may be associated with various electronics and the like housed within the printer 10, for example in an electronics panel 90. Additional details about a reservoir manifold are provided for in International Patent Application No. WO 2021/217102, entitled “Manifold and Related Methods for Use with a Reservoir for Additive Manufacturing,” the contents of which is incorporated by reference herein in its entirety.

In some embodiments, a magnetic additive alignment system 92 can be provided for as part of the printer 10. These magnetic additives can take several forms, including but not limited to fibers, particles or particulate matter having a non-spherical shape(s) and/or non-uniform aspect ratio(s), or platelets. Such a system 92 can help to control aspects of a print job when magnetic functional additives, such as magnetic particles like those described herein, are associated with the resin being printed, such as the resins disclosed herein and/or otherwise derivable from the present disclosures. More specifically, the system 92 can include one or more magnets and/or magnetic field generators that enable the location of the magnetic particle including resin to be controlled by the system 92. Other functional additives that are not necessarily magnetic can also be incorporated with the resin.

A touch screen 26 or other user interface can be included as part of the housing 20 to allow a user to input various parameters for a print job and/or for instructions, signals, warnings, or other information to be passed along by any systems of the printer 10 to a user. Still further, the housing 20 can include an openable and/or removable hood 28 that enables a printed part, as well as components of the printer 10, to be accessed. The hood 28 can also include a viewing portion, such as a window 29, that allows a user to view a print job being performed. As shown, the build plate 30, and thus a part being printed that will be attached to the build plate 30, can be seen through the window 29. Further, the reservoir 50, manifold 56, and other components of the printer 10 can also be visible through the window 29.

A person skilled in the art will understand how to apply the systems, methods, and the like disclosed herein to various additive manufacturing processes and printers. Some non-limiting examples of DLP printers and techniques with which the present disclosure can be used include those provided for in U.S. Pat. No. 10,703,052, entitled “Additive Manufacturing of Discontinuous Fiber Composites Using Magnetic Fields,” U.S. Pat. No. 10,732,521, entitled “Systems and Methods for Alignment of Anisotropic Inclusions in Additive Manufacturing Processes,” and the FLUX 3D printer series, including the aforementioned FLUX ONE 3D printer (further details about the FLUX 3D printer series provided for at http://3dfortify.com/ and https://3dfortify.com/tech-talks/?utm_campaign=Press%20Release&utm_medium=email&_hsmi=121056681&_hsenc=p2 ANqtz-8FkzgrKUqpdmX8htE0mGXDqHASskXxSVI_I_LgnnKsoZ_oCHiruVZLpFcDoACFbnSUDx4 x5HuO6G3SAs9sUij_skF2H1Q&utm_content=121056681&utm_source=hs_email, and related web pages), the contents of all, including any videos accessible at such web pages and related web pages, being incorporated by reference herein in their entireties. The videos incorporated by reference at the second provided web page include videos entitled “Fortify's Product and Services Ecosystem” (length 17 minutes), “CKM: Enabling the Printing of the Highest Performing DLP Materials” (length 9 minutes), “How Fluxprint Enables High Performance Materials for 3D Printing” (length 12 minutes), “Applications Highlight: Fortifying Mold Tools” (length 11 minutes), “Applications Highlight: 3D Printing Low Loss RF Devices” (length 13 minutes), “Tailoring Conductivity in Filled Photopolymers Using Fluxprint and CKM” (9 minutes), and “Innovation Through Collaboration :Fortify's Material Partnerships” (8 minutes).

The terms “3D” and “additive manufacturing” may be used interchangeably herein. In addition to DLP-style additive manufacturing printers, the methods and systems herein can be implemented at least on SLA additive manufacturing printers, LCD manufacturing printers, any other vat photopolymerization process printer, and with any printer that utilizes images in conjunction with its additive manufacturing process.

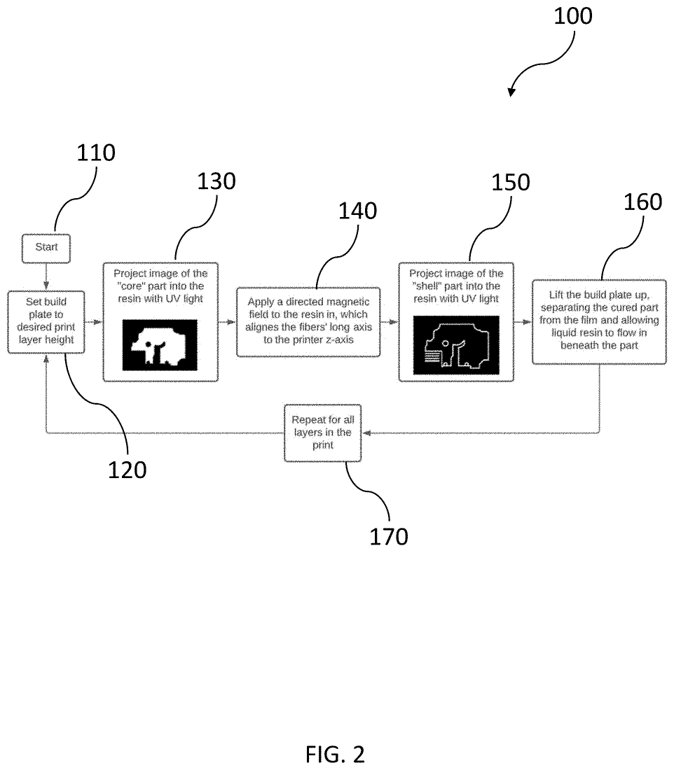

Turning to techniques provided for herein to combat shrinkage, FIG. 2 provides a flowchart detailing a method 100 for minimizing shrinkage in resin-printed components according to at least one embodiment. As shown, the method can be implemented in a computer readable medium to control a photopolymerization printer such that the core and shell images for a given print file can be generated based on a given print file. The method is initiated at a first step or action 110, identified as a “start” action, in which an initial build file is generated or otherwise provided to the printing system/printer/etc. At a step or action 120, a build plate of the printer (e.g., the build plate 30 of the printer 10) is set to a height of a first print layer, with the first print layer being a layer to be subjected to the shrinkage minimizing “shelling” techniques disclosed herein.

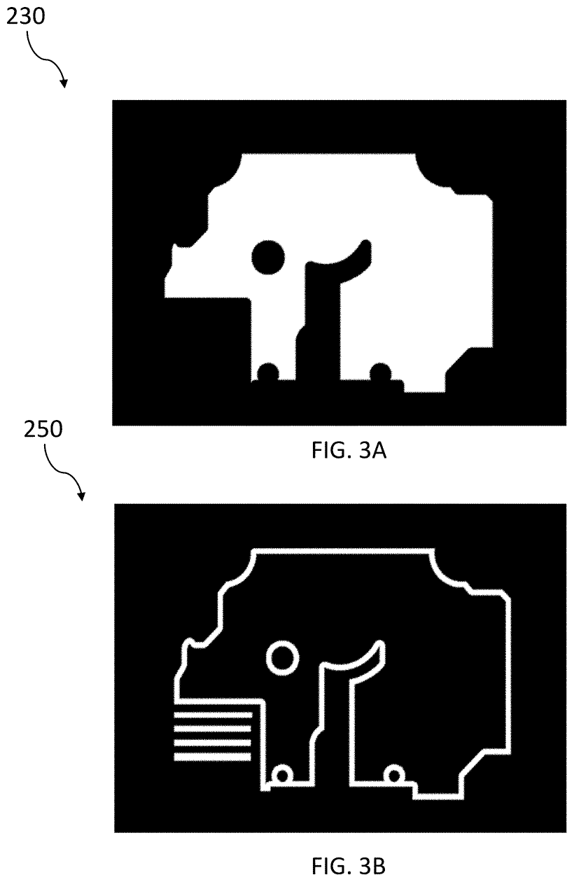

At step or action 130, a core image can be projected into a target photopolymer resin (e.g., resin disposed in the reservoir 50 of the printer 10). An expanded version of a sample core is shown as core 230 of FIG. 3A. At step or action 140, a magnetic field can be applied to the photopolymer resin (e.g., using the magnetic alignment system 92 of the printer 10), resulting in an alignment of additives in the photopolymer resin along an axis of the magnetic field, labeled as the printer's z-axis in the illustrated embodiment. At step or action 150, a shell image can be projected into the target photopolymer resin (e.g., resin disposed in the reservoir 50 of the printer 10). An expanded version of the sample shell is shown as shell 250 of FIG. 3B. According to at least some embodiments, the step or action 150 can occur prior to the step or action 130. At step or action 160, the build plate (e.g., the build plate 30) can be lifted, which can result in a separating of the cured part from the remaining liquid resin. As provided for at step or action 170, the steps or actions of the method 100 can be repeated for additional layers, such as a second print layer, third print layer, or generally an nth print layer, for the remaining layers of the additive manufacturing build. At the conclusion of the printing process, a part or component can be produced, the printing of that part having been optimized using this shelling technique to minimize an amount of shrinkage and/or curling that occurs with the material such that the produced part is optimally to-scale, shape, etc. as designed.

FIGS. 3A and 3B provide example “core” and “shell” images 230 and 250, respectively, within a single layer of a part to be printed that can be projected at steps 130 and 150, respectively. As illustrated, the “core” image 230 can be an interior area of a cross section of the part to be printed, and the “shell” image 250 can be a border of the core image 230 in some thickness of x-pixels. The “core” of the cross-section can include any remaining area not considered the “shell” and can vary in area based on the side and shape of the original cross-section. In most cases studied in conjunction with the present disclosure a “shell” width equivalent was approximately in the range of about 0.5 millimeters to about 2 millimeters, which can be considered preferential as it can create a situation in which the “shell” is sufficiently thick and the “core” represents a majority of the cross-sectional area, e.g., approximately 70% or greater. In general, the cross-sectional area of the core is controlled by the shell border size and the cross-sectional size. Even if the border size is fixed, the changing cross-section throughout an entire print can be such that the core is 0% of the area. Similarly, it can be as large as approximately 99.8% of the area. In the examples provided for in FIGS. 3A and 3B, the core represents approximately 90% of the cross-section. In conjunction with the illustrated embodiment of FIGS. 3A and 3B, a build plate (e.g., the build plate 30) can be plunged into a composite resin disposed in a reservoir (e.g., the reservoir 50) in a manner common in DLP bottom-up printing processes, as well as other known additive manufacturing processes disclosed herein or otherwise known to those skilled in the art. As discussed above with respect to FIG. 2, the composite photopolymer resin can contain a plurality of magnetically active additives, which can be manipulated by a magnetic alignment system of or otherwise associated with the printer (e.g., the magnetic alignment system 92). In other or the same embodiments, and as depicted in step 130 of FIG. 2, the center “core” section of a part can be cured while the additives can be aligned such that their long axes (if applicable) are parallel or substantially parallel with the printer x-y plane. It may be possible for the additives to be magnetically aligned. In at least some embodiments, this first-generated magnetic vector field can be substantially uniform across a plane parallel to the surface of a build plate, i.e., a build plane, or plane extending substantially or fully through a resin-contacting outer surface of the build plate (sometimes referred to as a “build plate plane”), that plane being parallel, or substantially parallel, with a ground plane. As used herein with respect to certain aspects being “substantially” parallel or perpendicular to other aspects, a person skilled in the art will appreciate what constitutes being close enough to parallel or perpendicular to be considered “substantially parallel” or “substantially perpendicular,” but it can typically mean at least within ±5 degrees of being parallel or perpendicular in some instances.

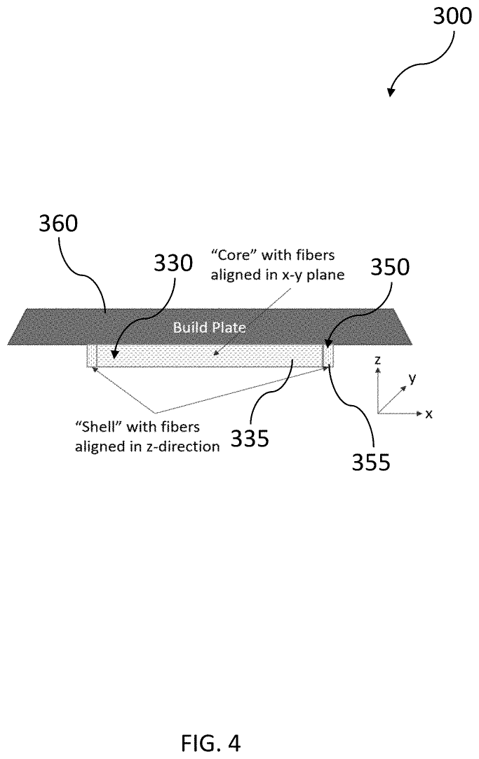

In a next step of a method according to at least some embodiments, without moving the build plate or z-axis, all the composite additives in the resin can be magnetically aligned pursuant to a second-generated magnetic vector field such that their long axes are parallel, or substantially parallel, with the printer z-axis as shown in step 140 of FIG. 2 (e.g., an axis traveling in a same direction as the longitudinal axis L of the printer 10). In at least some embodiments, this second-generated magnetic vector field can be substantially uniform, perpendicular, or substantially perpendicular, to the previously defined plane of the build plate, although, more generally, a person skilled in the art will understand a typical location of the plane of the printer and/or the build plate for purposes of this disclosure. This alignment can then be followed by curing the “shell” section at step 150 of FIG. 2, with a sample shell section being shown as shell 250 of FIG. 3B. This can result in a single-cured layer that can contain additives of two different orientations: a “core” with additives in the x-y plane; and a “shell” with additives aligned parallel, or substantially parallel, to the z-axis. A schematic of this resultant additive orientation 300 is shown in FIG. 4, with a shell 350 surrounding a core 330 and both abutting a build plate 360. The additives 335 of the core 330 can be parallel, or substantially parallel, to the plane of the build plate 360, while the additives 355 of the shell 350 can be perpendicular, or substantially perpendicular, to the same plane in the illustrated embodiment.

In the illustrated embodiment, the “core” section 330 can resist polymerization shrinking forces in the x-y plane by aligning additives 335 in plane with the shrinking forces. As a result, the additives 335 can reinforce the resin matrix of the printed part to resist the shrinking forces. In at least some such embodiments, this can allow for a printer to cure the resin, without significant shrinking of the layer, thus significantly reducing the degree to which a printed part is warped and distorted by polymerization shrinking forces. A person skilled in the art, in view of the present disclosures, will understand what constitutes “significant” as it relates to shrinkage; in particular, those of skill in the art will appreciate that shrinkage is akin to a manufacturing tolerance, such that the percentage of shrinkage will vary with the application of the printed part. In at least some particular geometries tested in conjunction with the present disclosure, the geometric flatness of a printed surface can be improved by approximately in the range of about 50% to about 70% by applying this technique, when compared to parts printed without the technique. The technique similarly improves dimensional accuracy by resisting shrinking forces. In at least some tested geometries, parts of prior art shrank in x and y dimensions by approximately 1%, while parts printed with this technique shrank by approximately 0.65%. The difference in shrinkage is significant in terms of dimensional tolerance, where targets of approximately 0.005″ (approximately 127 μm) are common. In at least some embodiments, the thinner “shell” section 350 that is cured can align with additives 355 in the z-direction, creating a shell of the part with smoother surfaces and a lower roughness as compared with printing techniques known to those skilled in the art that pre-date this disclosure, as well as improved mechanical properties in the z-axis direction. According to at least some embodiments, the x-y alignment of the additives 335 are accomplished by a magnetic field in a first phase, and the z-direction alignment of the additives 355 is accomplished by a magnetic field in a second phase. The fields in one alignment are thus in a different phase than fields in another alignment. These properties provide significant advantages, including, for example, injection molding applications. In at least some embodiments, the additives 355 aligned in the z-direction can increase z-direction mechanics in the same way as classic additive reinforcement in a composite system. In such embodiments, the alignment orientation can also produce smoother part surfaces, at least because less light is scattered and/or reflected off the additive surfaces in these orientations due to the present disclosures.

According to at least some embodiments this single-layer process can be repeated for multiple layers, including for each layer, of a printed part such that the entire part has a 3D “core” that can resist shrinkage, and a 3D attached shell that can improve mechanics and/or roughness. According to at least some embodiments, the core and shell images can be uniquely generated for each layer such that each layer has a shell of the same, or substantially the same, thickness. An example result of such a part 400 is shown in FIG. 5A, where the change in additive alignment can be observed as a change in color between the core 430 and the perimeter or shell 450 of printed part 400.

According to at least some embodiments, the warping reduction sought by the systems and methods disclosed herein can be quantified by measuring part parallelism 466 of a part 462 to a granite surface plate 464, such as shown in FIG. 5B. In some such embodiments, the part 462 can be placed on the surface plate 464 such that a last layer printed is on the plate 464, and a first layer printed is facing up. A digital indicator can be used to measure the height of the part at many points, which are in turn can be used to describe the parallelism 466. At least one embodiment of a test geometry 470 used in this manner is shown in FIG. 5C.

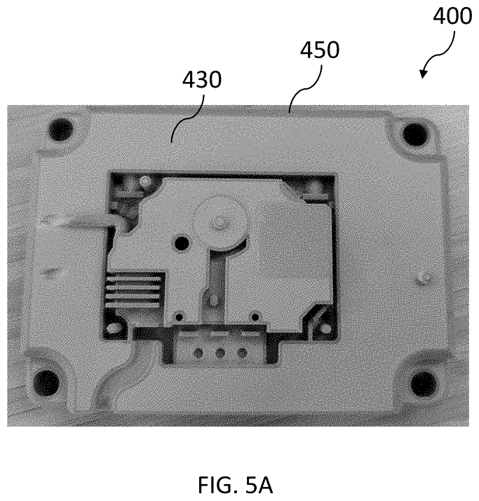

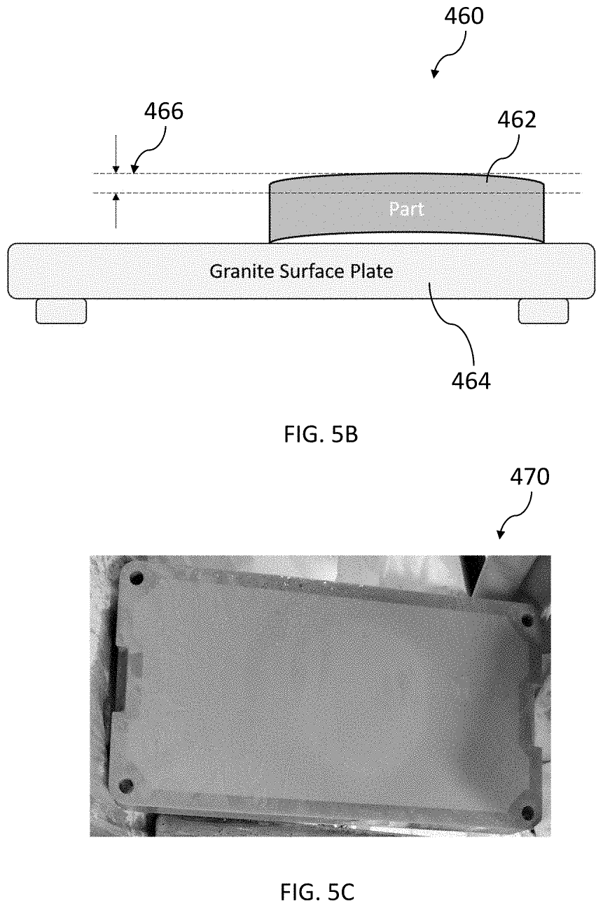

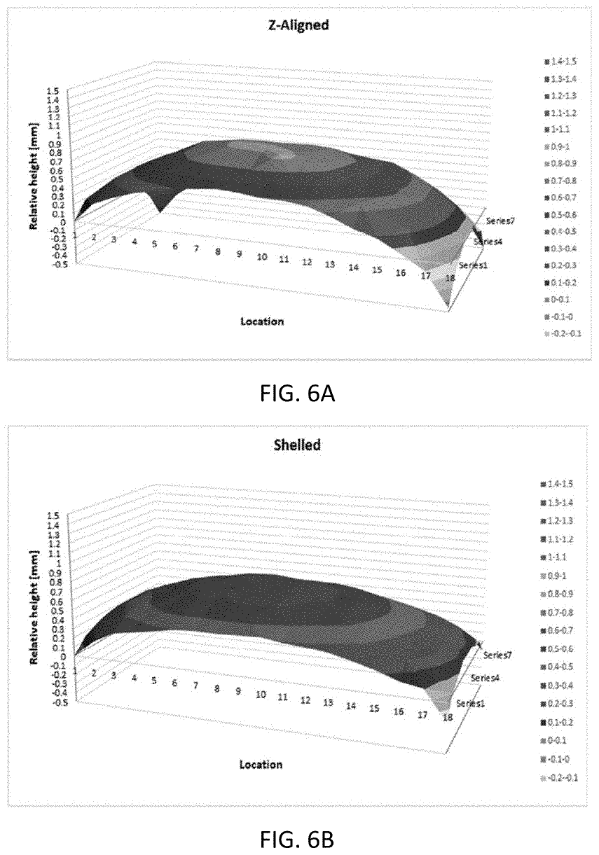

FIGS. 6A and 6B are charts that compare a control case of FIG. 6A (where all additives are substantially aligned in the z-direction in both the core and the shell) to a shelled case of FIG. 6B, developed using at least one embodiment of a system and method described herein. The images in these two figures are graphs representing the measured parallelism described in the previous paragraph. They represent the measured face of a printed part that is intended to be flat. They help illustrate that the geometric parallelism of the “shelled” part in FIG. 6B, which uses the present technique, has improved parallelism as compared to the “z-aligned” case in FIG. 6A, which represents the capabilities of techniques known prior to the present disclosure.

According to a least some embodiments, the width of the shelled portion can be variable, such as embodiments where it may be advantageous or necessary to optimize a printed part according to certain materials or geometries. At least some embodiments can include partial additive alignment cases, with additives aligned to some angle between z and x-y axes. According to at least some embodiments, the entire part can be printed with additives in the x-y orientation, and then sanded and/or polished after it is printed and/or cured.

According to at least some embodiments, the desired dose of the core and shell can be variable, such as embodiments where it may be advantageous or necessary to optimize a printed part according to certain materials or geometries. According to at least some embodiments, this would include changing either the intensity of the light, the exposure time, or both. Further, according to at least some embodiments, alterations to magnetic field intensity, topology, and/or duration acting on the additives disclosed herein will adjust the overall angular distribution of the additives on which the magnetic field acts, allowing for additional variations in additive angular distribution as needed in the production of complex parts. As provided for herein, to the extent there are multiple alignments across a part, the alignments can have their own energy levels.

In at least some embodiments, two or more different additive alignment orientations can be patterned within a layer or part, such as embodiments tailored to part properties that can be programmable through additive alignment. In other or the same embodiments, the color change imparted by the aligned additives can be used to convey information, such as a bar code or text.

In at least some embodiments, one can perform a three-dimensional shelling by converting the image stack into a matrix that then performs a distance transform in three dimensions. One skilled in the art can see that certain parts may require this for final part properties.

One can reduce the time to complete a shelling process by partially curing the core until the additives are programmed to be in the X-Y plane and the polymer matrix is sufficiently strong to withstand the torque that magnets impart on the additives. One of skill in the art will recognize what percent of cure is required to limit the effects of this torque. According to such embodiments, the core can be partially cured prior to the introduction of the magnetic field, and this can occur while the core is still being projected into the build plane. According to at least some of such embodiments, when the cure is complete for the core and the magnetic field duration is sufficient for alignment of the shell, the shell can then be projected into the build plane and/or resin disposed in a tank or reservoir.

The present disclosure provides for further improvements for determining the shell thickness. Rather than solely relying on a user/operator to know what n-pixel thickness the user would want to use, the user can select a percent-pixel thickness as related to the thickness of each part in the build. Further, the user can also select if there should be upper, lower, or both bounds on how thick or thin the shell is allowed to get with the part.

At least some embodiments employ an edge case detection. If a printed part were to touch the edge of a projected image absent any edge detection, that side of the part would be less likely to shell properly. In embodiments employing this additional corrective technique, every input image into the shelling process can be expanded with, by way of example, a border of one (1) pixel thick with values of zero. The projected image can then be trimmed of this one (1) pixel border to prevent any scaling of the image that is unintentional. In other embodiments, this border may be larger than one (1) pixel.

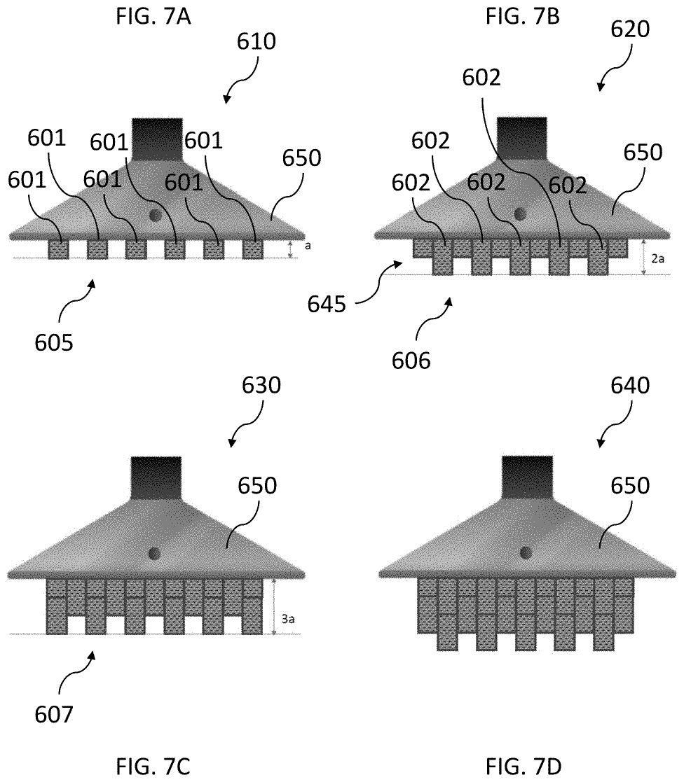

According to another embodiment, FIGS. 7A-D illustrate a castellation technique. As shown, a build layer can be divided into a checkerboard pattern of some unit size measured, for example, in terms of projected pixels. The build layer can then be subdivided into sublayers 605 (FIG. 7A), 606 (FIG. 7B), and 607 (FIG. 7C), where in the illustrated embodiment each sublayer has a depth “a.” In the first sublayer 605, shown in FIG. 7A, a first checkerboard pattern 601 is cured at step or action 610 at height “a.” The build plate 650 is then moved upward by another increment of “a,” shown as “2a” in FIG. 7B, and an alternate checkerboard pattern of the first checkerboard pattern 601, illustrated as a second checkerboard pattern 602, is cured at step or action 620 in the second sublayer 606. This results in a staggered-height checkerboard 645, where one cured checkerboard pattern is “a” distance taller than the other checkerboard pattern. The build plate 650 is then moved up another distance “a,” shown as “3a” in FIG. 7C, to cure a third sublayer 607, with the same first checkerboard pattern being cured at step or action 630. These steps can be repeated as an aggregate step or action 640, illustrated in FIG. 7D, to cure the entirety of a print layer. According to at least some embodiments, this castellation technique can be utilized in the curing of an entire part. According to at least some embodiments, shelling techniques as described herein can be combined with castellation techniques provided for herein or otherwise known to those skilled in the art to improve part stability.

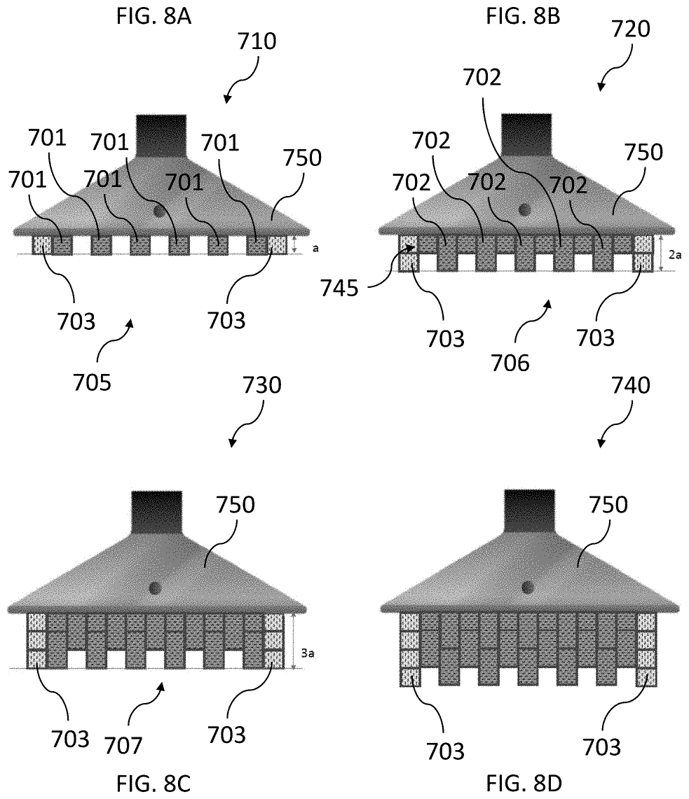

According to another embodiment, FIGS. 8A-D illustrate a castellation technique with the addition of a shelling technique. As shown, a build layer can be divided into a checkerboard pattern of some unit size measured, for example, in terms of projected pixels. The build layer can then be subdivided into sublayers 705 (FIG. 8A), 706 (FIG. 8B), and 707 (FIG. 8C), where in the illustrated embodiment each sublayer has a depth “a.” In the first sublayer 705, shown in FIG. 8A, a first checkerboard pattern of a core 701 is cured at step or action 710 at height “a.” This is then followed by altering an orientation or phase of the magnetic field and curing a shell 703. The build plate 750 is then moved upward by another increment of “a,” shown as “2a” in FIG. 8B, and an alternate checkerboard pattern of the first checkerboard pattern 701, illustrated as a second checkerboard pattern 702 of the core, is cured at step or action 720 in the second sublayer 706. This results in a staggered-height checkerboard 745, where one cured checkerboard pattern is “a” distance taller than the other checkerboard pattern. This is then followed by altering an orientation or phase of the magnetic field and curing the shell 703. The build plate 750 is then moved up another distance “a,” shown as “3a” in FIG. 8C, to cure a third sublayer 707, with the same first checkerboard pattern of the core being cured at step or action 730, and a magnetic field orientation or phase is similarly altered before curing the shell 703. These steps can be repeated as an aggregate step or action 740, illustrated in FIG. 8D, to cure the entirety of a print layer and related shell 703. According to at least some embodiments, this castellation and shelling technique can be utilized in the curing of an entire part.

An additional advantage of an anchoring technique is that resins and materials that do not have magnetically addressable additives can still be subjected to a partial anchoring technique. For example, one can perform the technique(s) where there is no core or shell, but the half layer checkerboard pattern can be printed at a partial layer thickness and then the rest of the image can be projected.

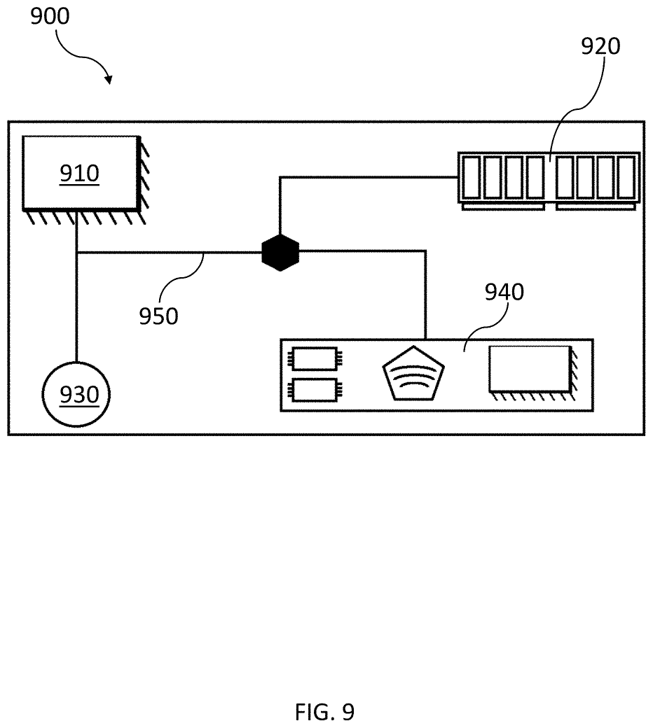

Implementation of the present disclosures on a computer readable medium can include a central processing unit (CPU), memory, and/or support circuits (or I/O), among other features. In embodiments having a memory, that memory can be connected to the CPU, and may be one or more of a readily available memory, such as a read-only memory (ROM), a random access memory (RAM), floppy disk, hard disk, cloud-based storage, or any other form of digital storage, local or remote. Software instructions, algorithms, and data can be coded and stored within the memory for instructing the CPU. Support circuits can also be connected to the CPU for supporting the processor in a conventional manner. The support circuits may include conventional cache, power supplies, clock circuits, input/output circuitry, and/or subsystems, and the like. Output circuitry can include circuitry allowing the processor to control a magnetic field generator, light source, and/or other components of an additive photopolymerization printer. In some embodiments, a user can selectively employ the methods described herein, or otherwise derivable from the present disclosure, within image slices produced in the computer readable medium. At least one embodiment of a computer readable medium is given by FIG. 9.

More particularly, FIG. 9 shows a block diagram of one exemplary embodiment of a computer system 900 upon which the present disclosures can be built, performed, operated, trained, etc. For example, any of the methods provided for herein can be implemented by way of the computer system 900. The system 900 can include a processor 910, a memory 920, a storage device 930, and an input/output device 940. Each of the components 910, 920, 930, and 940 can be interconnected, for example, using a system bus 950. The processor 910 can be capable of processing instructions for execution within the system 900. The processor 910 can be a single-threaded processor, a multi-threaded processor, or similar device. The processor 910 can be capable of processing instructions stored in the memory 920 or on the storage device 930. The processor 910 may execute one or more of the operations described herein.

The memory 920 can store information within the system 900. In some implementations, the memory 920 can be a computer-readable medium. The memory 920 can, for example, be a volatile memory unit or a non-volatile memory unit. In some implementations, the memory 920 can store information related to various airfoils, structural parameters, performance parameters, and optimization landscapes, among other information.

The storage device 930 can be capable of providing mass storage for the system 900. In some implementations, the storage device 930 can be a non-transitory computer-readable medium. The storage device 930 can include, for example, a hard disk device, an optical disk device, a solid-date drive, a flash drive, magnetic tape, and/or some other large capacity storage device. The storage device 930 may alternatively be a cloud storage device, e.g., a logical storage device including multiple physical storage devices distributed on a network and accessed using a network. In some implementations, the information stored on the memory 920 can also or instead be stored on the storage device 930.

The input/output device 940 can provide input/output operations for the system 900. In some implementations, the input/output device 940 can include one or more of network interface devices (e.g., an Ethernet card), a serial communication device (e.g., an RS-232 10 port), and/or a wireless interface device (e.g., a short-range wireless communication device, an 802.7 card, a 3G wireless modem, a 4G wireless modem, a 5G wireless modem). In some implementations, the input/output device 940 can include driver devices configured to receive input data and send output data to other input/output devices, e.g., a keyboard, a printer, and/or display devices. In some implementations, mobile computing devices, mobile communication devices, and other devices can be used.

In some implementations, the system 900 can be a microcontroller. A microcontroller is a device that contains multiple elements of a computer system in a single electronics package. For example, the single electronics package could contain the processor 910, the memory 920, the storage device 930, and/or input/output devices 940.

One skilled in the art will appreciate further features and advantages of the present disclosure based on the above-described embodiments. Accordingly, the disclosure is not to be limited by what has been particularly shown and described, except as indicated by the appended claims. Further, a person skilled in the art, in view of the present disclosures, will understand how to implement the disclosed systems and methods provided for herein in conjunction with DLP-style additive manufacturing printers, stereolithography (SLA) additive manufacturing printers, liquid crystal display (LCD) manufacturing printers, vat photopolymerization process printers generally, and additive manufacturing processes that involve building images layer-by-layer generally. All publications and references cited herein are expressly incorporated herein by reference in their entireties.

Although an example embodiment has been described above, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a processing system. The computer readable medium can be a machine-readable storage device, a machine-readable storage substrate, a memory device, a composition of matter effecting a machine-readable propagated signal, or a combination of one or more of them.

Various embodiments of the present disclosure may be implemented at least in part in any conventional computer programming language. For example, some embodiments may be implemented in a procedural programming language (e.g., “C” or ForTran95), in an object-oriented programming language (e.g., “C++”), and/or other programming languages (e.g. Java, JavaScript, PHP, Python, and/or SQL). Other embodiments may be implemented as a pre-configured, stand-along hardware element and/or as preprogrammed hardware elements (e.g., application specific integrated circuits, FPGAs, and digital signal processors), or other related components.

The term “computer system” may encompass all apparatus, devices, and machines for processing data, including, by way of non-limiting examples, a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. a program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Such implementation may include a series of computer instructions fixed either on a tangible, non-transitory medium, such as a computer readable medium. The series of computer instructions can embody all or part of the functionality previously described herein with respect to the system. Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. The components of the system can be interconnected by any form or medium of digital data communication, e.g., a communication network. Examples of communication networks include a local area network (“LAN”) and a wide area network (“WAN”), e.g., the Internet.

Those skilled in the art should appreciate that such computer instructions can be written in a number of programming languages for use with many computer architectures or operating systems. Furthermore, such instructions may be stored in any memory device, such as semiconductor, magnetic, optical, or other memory devices, and may be transmitted using any communications technology, such as optical, infrared, microwave, or other transmission technologies.

Among other ways, such a computer program product may be distributed as a removable medium with accompanying printed or electronic documentation (e.g., shrink-wrapped software), preloaded with a computer system (e.g., on system rom or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the present disclosure may be implemented as a combination of both software (e.g., a computer program product) and hardware. Still other embodiments of the present disclosure are implemented as entirely hardware, or entirely software.

Examples of the above-described embodiments can include the following:
1. A digital light processing (DLP) printer, comprising:
   a reservoir configured to have a photopolymer resin material disposed therein, the photopolymer resin including a plurality of magnetically active additives;
   a magnetic field generator;
   a build plate disposed above the reservoir and configured to at least move along a vertical axis, away from the reservoir;
   a digital light projector configured to project an image of a part to be printed towards the reservoir; and
   a processor, configured to:
      subdivide a build file into at least one printing layer;
      create a first image and a second image for the at least one printing layers;
      instruct the magnetic field generator to apply a first magnetic field;
      instruct the digital light projector to project the first image;
      instruct the magnetic field generator to apply a second magnetic field; and
      instruct the digital light projector to project the second image,
      wherein the first magnetic field and the second magnetic field are out of phase.
2. The DLP printer of example 1,
   wherein the first image comprises a core image, the core image including an interior area of an image to be printed on the at least one printing layer, and
   wherein the second image comprises a shell image, the shell image including a perimeter of the image to be printed on the at least one printing layer.
3. The DLP printer of example 2, wherein the shell image comprises a perimeter of constant thickness.
4. The DLP printer of any of examples 1 to 3,
   wherein the first magnetic field comprises a substantially uniform vector field, and
   wherein vectors of the substantially uniform vector field are directed in the x-y plane.
5. The DLP printer of any of examples 1 to 4,
   wherein the second magnetic field comprises a substantially uniform vector field, and
   wherein vectors of the substantially uniform vector field are directed along the z axis.
6. A method for printing a part using digital light processing (DLP) printing, comprising:
   subdividing a build file into at least one printing layer;
   plunging a build plate of a DLP printer into a composite resin, the composite resin including magnetically active additives;
   curing, with a digital light processor, a first image of the at least one printing layer; applying a magnetic field having a first phase to the at least one printing layer;
   curing, with the digital light processor, a second image of the at least one printing layer;
and
   applying a magnetic field having a second phase to the at least one printing layer.
7 The method of example 6,
   wherein the first image comprises a core image, the core image including a majority of an image to be printed on the at least one printing layer, and
   wherein the second image comprises a shell image, the shell image including a perimeter of the image to be printed on the at least one printing layer.
8. The method of example 7, wherein the shell image comprises a perimeter of constant thickness.
9. The method of any of examples 6 to 8,
   wherein the first magnetic field comprises a substantially uniform vector field, and
   wherein vectors of the substantially uniform vector field are directed in the x-y plane.

10. The method of any of examples 6 to 9,
wherein the second magnetic field comprises a substantially uniform vector field, and
wherein vectors of the substantially uniform vector field are directed along the z axis.
11. A digital light processing (DLP) printer, comprising:
   a reservoir configured to have a photopolymer resin material disposed therein, the photopolymer resin including a plurality of magnetically active additives;
   a build plate disposed above the reservoir and configured to at least move along a vertical axis, away from the reservoir;
   a digital light projector configured to project an image of a part to be printed towards the reservoir; and
   a processor, configured to:
      subdivide a build file into at least one printing layer;
      subdivide the at least one printing layer into a plurality of sublayers;
      create a first image corresponding to a first sublayer, the first image being in a first checkerboard pattern;
      instruct the digital light projector to project the first image;
      instruct the build plate to move to a position corresponding to a second sublayer;
      create a second image corresponding to the second sublayer, the second image being is in a second checkerboard pattern;
      instruct the digital light projector to project the second image;
      instruct the build plate to move to a position corresponding to a third sublayer;
      create a third image corresponding to the third sublayer, the third image being in the first checkerboard pattern; and
      instruct the digital light projector to project the third image.
12. The DLP printer of example 11,
   wherein each of the first image, the second image, and the third image comprises:
      an interior area core; and
      an edge shell,
   wherein the DLP printer further comprises:
      a magnetic field generator capable of generating a magnetic field,
   wherein the magnetic field generated by the magnetic field generator is in a first phase when the digital light projector is instructed to project the interior area core of each of the first image, the second image, and the third image, and
   wherein the magnetic field generated by the magnetic field generator is in a second phase when the digital light projector is instructed to project the edge shell of each of the first image, the second image, and the third image.
13. A method for printing a part using digital light processing (DLP) printing, comprising:
   subdividing a build file into at least one printing layer;
   subdividing the at least one printing layer into a plurality of sublayers;
   creating a first image corresponding to a first sublayer, the first image being in a first checkerboard pattern;
   instructing the digital light projector to project the first image;
   instructing the build plate to move to a position corresponding to a second sublayer;
   creating a second image corresponding to the second sublayer, the second image being is in a second checkerboard pattern;
   instructing the digital light projector to project the second image;
   instructing the build plate to move to a position corresponding to a third sublayer;
   creating a third image corresponding to the third sublayer, the third image being in the first checkerboard pattern; and
   instructing the digital light projector to project the third image.
14. The method for printing a part of example 13,
   wherein each of the first image, the second image, and the third image comprises:
      an interior area core; and
      an edge shell,
   wherein a magnetic field generated by a magnetic field generator is in a first phase when the digital light projector is instructed to project the interior area core of each of the first image, the second image, and the third image, and
   wherein the magnetic field is in a second phase when the digital light projector is instructed to project the edge shell of each of the first image, the second image, and the third image.

One skilled in the art will appreciate further features and advantages of the present disclosure based on the above-described embodiments. Accordingly, the disclosure is not to be limited by what has been particularly shown and described, except as indicated by the appended claims. Further, a person skilled in the art, in view of the present disclosures, will understand how to implement the disclosed systems and methods provided for herein in conjunction with any type of three-dimensional printer that uses images in conjunction with producing a part or component, including but not limited to any DLP-style additive manufacturing printers. All publications and references cited herein are expressly incorporated herein by reference in their entireties.

What is claimed is:

1. A digital light processing (DLP) printer, comprising:
a reservoir configured to have a photopolymer resin material disposed therein, the photopolymer resin including a plurality of magnetically active additives;
a magnetic field generator;
a build plate disposed above the reservoir and configured to at least move along a vertical axis, away from the reservoir;
a digital light projector configured to project an image of a part to be printed towards the reservoir; and
a processor, configured to:
subdivide a build file into at least one printing layer;
create a first image and a second image for the at least one printing layers;
instruct the magnetic field generator to apply a first magnetic field;
instruct the digital light projector to project the first image;
instruct the magnetic field generator to apply a second magnetic field; and
instruct the digital light projector to project the second image,
wherein the first magnetic field and the second magnetic field are out of phase.

2. The DLP printer of claim 1,
wherein the first image comprises a core image, the core image including an interior area of an image to be printed on the at least one printing layer, and
wherein the second image comprises a shell image, the shell image including a perimeter of the image to be printed on the at least one printing layer.

3. The DLP printer of claim 2, wherein the shell image comprises a perimeter of constant thickness.

4. The DLP printer of claim 1,
wherein the first magnetic field comprises a substantially uniform vector field, and
wherein vectors of the substantially uniform vector field are directed in the x-y plane.

5. The DLP printer of claim 1,
wherein the second magnetic field comprises a substantially uniform vector field, and
wherein vectors of the substantially uniform vector field are directed along the z axis.

6. A method for printing a part using digital light processing (DLP) printing, comprising:
subdividing a build file into at least one printing layer;
plunging a build plate of a DLP printer into a composite resin, the composite resin including magnetically active additives;
curing, with a digital light processor, a first image of the at least one printing layer;
applying a magnetic field having a first phase to the at least one printing layer;
curing, with the digital light processor, a second image of the at least one printing layer;
and
applying a magnetic field having a second phase to the at least one printing layer.

7 The method of claim 6,
wherein the first image comprises a core image, the core image including a majority of an image to be printed on the at least one printing layer, and
wherein the second image comprises a shell image, the shell image including a perimeter of the image to be printed on the at least one printing layer.

8. The method of claim 7, wherein the shell image comprises a perimeter of constant thickness.

9. The method of claim 6,
wherein the first magnetic field comprises a substantially uniform vector field, and
wherein vectors of the substantially uniform vector field are directed in the x-y plane.

10. The method of claim 6,
wherein the second magnetic field comprises a substantially uniform vector field, and
wherein vectors of the substantially uniform vector field are directed along the z axis.

11. A digital light processing (DLP) printer, comprising:
a reservoir configured to have a photopolymer resin material disposed therein, the photopolymer resin including a plurality of magnetically active additives;
a build plate disposed above the reservoir and configured to at least move along a vertical axis, away from the reservoir;
a digital light projector configured to project an image of a part to be printed towards the reservoir; and
a processor, configured to:
subdivide a build file into at least one printing layer;
subdivide the at least one printing layer into a plurality of sublayers;
create a first image corresponding to a first sublayer, the first image being in a first checkerboard pattern;
instruct the digital light projector to project the first image;
instruct the build plate to move to a position corresponding to a second sublayer;
create a second image corresponding to the second sublayer, the second image being is in a second checkerboard pattern;
instruct the digital light projector to project the second image;
instruct the build plate to move to a position corresponding to a third sublayer;
create a third image corresponding to the third sublayer, the third image being in the first checkerboard pattern; and
instruct the digital light projector to project the third image.

12. The DLP printer of claim 11,
wherein each of the first image, the second image, and the third image comprises:
an interior area core; and
an edge shell,
wherein the DLP printer further comprises:
a magnetic field generator capable of generating a magnetic field,
wherein the magnetic field generated by the magnetic field generator is in a first phase when the digital light projector is instructed to project the interior area core of each of the first image, the second image, and the third image, and
wherein the magnetic field generated by the magnetic field generator is in a second phase when the digital light projector is instructed to project the edge shell of each of the first image, the second image, and the third image.

13. A method for printing a part using digital light processing (DLP) printing, comprising:
subdividing a build file into at least one printing layer;
subdividing the at least one printing layer into a plurality of sublayers;
creating a first image corresponding to a first sublayer, the first image being in a first checkerboard pattern;
instructing the digital light projector to project the first image;
instructing the build plate to move to a position corresponding to a second sublayer;
creating a second image corresponding to the second sublayer, the second image being is in a second checkerboard pattern;
instructing the digital light projector to project the second image;
instructing the build plate to move to a position corresponding to a third sublayer;
creating a third image corresponding to the third sublayer, the third image being in the first checkerboard pattern; and
instructing the digital light projector to project the third image.

14. The method for printing a part of claim 13,
wherein each of the first image, the second image, and the third image comprises:
an interior area core; and
an edge shell,
wherein a magnetic field generated by a magnetic field generator is in a first phase when the digital light projector is instructed to project the interior area core of each of the first image, the second image, and the third image, and
wherein the magnetic field is in a second phase when the digital light projector is instructed to project the edge shell of each of the first image, the second image, and the third image.
